(19) United States
(12) Patent Application Publication
(10) Pub. No.: US 2010/0095774 A1
(43) Pub. Date: Apr. 22, 2010

(54) MASS MEASURING DEVICE AND CANTILEVER

(75) Inventors: Hayato Sone, Kiryu-shi (JP); Sumio Hosaka, Kiryu-shi (JP); Haruki Okano, Kiryu-shi (JP); Mitsumasa Suzuki, Kiryu-shi (JP)

Correspondence Address: DITTHAVONG MORI & STEINER, P.C., 918 Prince Street, Alexandria, VA, 22314, US

(73) Assignees: National University Corporation Gunma University, Gunma (JP); Kabushikikaisha Tokyo Sokki Kenkyujo, Shinagawa-ku, Tokyo (JP)

(21) Appl. No.: 12/517,805

(22) PCT Filed: Dec. 5, 2007
(86) PCT No.: PCT/JP2007/073518

§ 371 Date: Nov. 11, 2009

(30) Foreign Application Priority Data
Dec. 5, 2006 (JP) 2006-328427

(51) Int. Cl. G01N 29/00

(52) U.S. Cl. 73/580

(57) ABSTRACT

Minute masses of a plurality of measuring objects are measured at a time.

A multi-lever is prepared, in which a plurality of cantilevers, each having a buried piezoresistance element, is provided. Different measuring object attracting substances are coated on the multi-lever. The multi-lever is driven by a single vibration exciting device. The vibrational frequency is swept within a predetermined range, and the resonance frequency of each cantilever is detected. Frequency changes before putting in and after putting in the measuring object are detected, and based on this, the mass changes are calculated.

### TECHNICAL FIELD

The present invention relates to a mass measuring apparatus for measuring minute mass, and technique suitably applied to a cantilever as a sensor for use in the apparatus.

### BACKGROUND ART

With the evolution of nanotechnology and biotechnology, demand for measuring minute objects is increasing.

As the technology for measuring minute objects, the technology using a cantilever is known.

FIG. 9 illustrates a minute-mass measuring system of background art by the same inventor, which uses a cantilever 902.

The cantilever 902 for measuring minute objects is, for example, an extremely small cantilever, about 100 μm in length, about 50 μm in width, about 4 μm in thickness, and made of semiconductor material or corrosion-resistant metal or alloy.

In the detection end portion of the cantilever 902, a detection sensor 903, which is made of a piezoresistance, is buried. In the support portion of the cantilever 902, a vibration exciting actuator 904, which is made of a piezoelectric element, is attached.

The detection sensor 903 is connected to a detection circuit 905, which is made of a Wheatstone bridge. The detection circuit 905 takes out a signal from a midpoint of the Wheatstone bridge, and the signal is amplified at an amplifying circuit 906 made of an operational amplifier. An output signal amplified at the amplifying circuit 906 is input to a positive feedback circuit 907, which is made of a bandpass filter similarly constituted by an operational amplifier, etc. and an amplifying circuit. The vibration actuator 904 is driven by an output of the positive feedback circuit 907.

The vibration exciting actuator 904, the cantilever 902, the detection sensor 903, the detection circuit 905, the amplifying circuit 906, and the positive feedback circuit 907 constitute a positive feedback oscillator. And, the oscillatory frequency thereof becomes the natural vibrational frequency of the cantilever 902.

If a substance attaches to the cantilever 902, the mass of the cantilever 902 increases, and thereby the natural vibrational frequency of the cantilever 902 decreases. That is, this change of the natural vibrational frequency corresponds to the increase of the mass of the test object attached to the cantilever 902.

An FM demodulating circuit 908 is a circuit detecting this change of the natural vibrational frequency, and here, the change in frequency is detected as a DC component signal. This signal is primarily input to a PC system 909, which is made of a PC and predetermined software. The PC system 909 constitutes a so-called data logger that A/D converts and records output signals of the FM demodulating circuit 908, for a predetermined period of time. As the software constituting the data logger, for example, “LabVIEW” (registered trademark) of National Instrument Corporation, etc. are known.

FIG. 10 is a diagram explaining an operation of the minute-mass measuring system.

FIGS. 10(a) and 10(b) illustrate the cantilevers 902 immersed in water 1002.

FIG. 10(a) shows a stage before a measuring object 1003 is put into the water 1002, and FIG. 10(b) shows a sate after the measuring object 1003 has been put into the water 1002.

On the surface of the cantilever 902, a substance that attracts the measuring object 1003 is coated in advance. Then, if the measuring object 1003, for example, an allergen, etc., is put in the water 1002 through a micropipette 1004, the measuring object 1003 attaches to the surface of the cantilever 902. That is, the mass of the whole cantilever 902 increases even though the increase is extremely minute.

FIG. 10(c) illustrates a result of measuring changes in the vibrational frequency of the cantilever 902. Here, note that the vertical axis does not represent a frequency but represents a frequency change (Δf). Here, the reason for taking the frequency change on the vertical axis is that because the oscillatory frequency is about 100-500 kHz, and the change in frequency is minute, about several tens Hz. In FIG. 10(c), although no vibrational frequency change is present first (FIG. 10(a)), as the measuring object 1003 is put in, the measuring object 1003 starts to attach to the cantilever 902, and the mass of the cantilever 902 increases. With this increase of the mass, the natural vibrational frequency of the cantilever 902 gradually decreases. And, when the phenomenon that the measuring object 1003 attaches to the cantilever 902 ends, the vibrational frequency that has continued to change converges to a constant value. FIG. 10(d) is a diagram illustrating changes in the mass of the measuring object 1003 attached to the cantilever 902, which has been derived from the measurement result of FIG. 10(c).

FIGS. 11(a) and 11(b) are diagrams illustrating a procedure of measuring antigen-antibody reaction with the minute-mass measuring system.

In FIG. 11(a), after supplying egg albumen first as an antigen 1102 using a micropipette 1004, immunoglobulin serving as an antibody 1103 is supplied through the micropipette 1004. On the other hand, FIG. 11(b) illustrates a case that the egg albumen and immunoglobulin are supplied in the opposite procedure. The antibody 1103 (immunoglobulin) in FIG. 11(a) has an end portion on the side attaching to the antigen 1102, so that the antibody 1103 is easy to attach to the antigen 1102, however, if the supply procedure is carried out in the opposite way as in FIG. 11(b), it is understood that the attaching mechanism also becomes different.

FIGS. 12(a) and 12(b) are diagrams illustrating results of measuring antigen-antibody reaction using the minute-mass measuring system 901 according to the procedure of FIG. 11(a).

FIG. 12(a) illustrates the shift in frequency. When egg albumen as the antigen 1102 is first supplied, at the time that about 6 to 10 minutes have elapsed, it ends up with the frequency change of −144.5 Hz. When immunoglobulin as the antibody 1103 is put in next, at the time that 8-10 minutes have further elapsed, it ends up with the frequency change of −215.5 Hz. FIG. 12(b) is a diagram illustrating a result of calculating the change in the mass of the cantilever 902 due to the substance attached thereto. It is understood that 27.7 pg of the antigen 1102 and 41.3 pg of the antibody 1103 have attached.

As described above, the minute-mass measuring system 901 based on self-excited vibration can measure extremely minute mass with high accuracy. Also, unlike a measuring method using an optical system cantilever, which is background art in the past, measurement while being immersed in liquid is feasible. Further, unlike the optical system, purely the increase of mass is detected, so that the measurement result does not depend on the direction of the cantilever.

The above-described system having such superior characteristics is expected to be applied to wide applications as a biosensor.

Patent Document 1: Japanese Unexamined Patent Application Publication No. 2006-214744

Non-patent Document 1: H. P. Lang, et al., Analytica ZChimca Acta 393 (1999) 59-65

### DISCLOSURE OF THE INVENTION

It often occurs that reactions of a plurality of substances are desired to be compared. The above-described minute-mass measuring system has become simple and easy to handle compared with the measuring technique in the past, and the measuring accuracy has been improved as well, however, a reasonable time is required for measurement. Particularly, when the measuring object is a substance originating from a living body, it cannot be avoided that the reaction process takes time.

On the other hand, in every technology area, product development competition accompanying technology advancement is increasing. In the field of biogenic science also, results must be obtained in short time as much as possible. Preparing a plurality of the above-described minute-mass measuring systems is not so practical, because the facilities themselves that are necessary for measurement are expensive and it takes time and effort, etc.

Meanwhile, a sensor system in which optical detection technique has been applied is also available as background art (Non-patent Document 1), although it is a sensor system using the same cantilever. A plurality of cantilevers is disclosed in this document.

However, the optical detection technique is very troublesome to adjust, and cannot be used in water.

Further, the self-excited vibration according to the above-described background art cannot be used with respect to a plurality of cantilevers. This is because that the self-excited vibration is not feasible unless the vibration generating means and the cantilever are integrated.

The present invention has been made in view of the above-described points, and aims to provide a minute-mass detection element and a minute-mass measuring apparatus that realize a plurality of mass measurements at the same time with a few devices.

The present invention for solving the above-described problems vibrate first and second cantilevers, to which vibration detectors are attached, respectively, at variable frequencies, by a vibration exciting device, using an oscillator. Then, after recording signals caused by this vibration with a recording device, recorded data are analyzed to measure natural vibrational frequencies of respective cantilevers. And, the masses of measuring object substances attached to respective cantilevers are calculated by a mass calculation unit based on the natural vibrational frequencies.

When driving a plurality of cantilevers by a single vibration exciting device, the resonance phenomenon cannot be used. Therefore, the inventor has invented technique to cause vibration exciting frequencies to be swept and to grasp the resonance phenomenon within the range thereof. With this technique, it becomes unnecessary to prepare a plurality of vibration exciting devices, and it is possible to handle a plurality of measuring objects at the same time.

With the present invention, it is possible to provide a mass measuring apparatus for measuring minute mass, that is capable of handling a plurality of measuring objects at the same time, with a device configuration, which is simpler than before, and a cantilever for use in the apparatus, as well.

### BRIEF DESCRIPTION OF THE DRAWINGS

FIG. 1 is a block diagram of a minute-mass measuring system according to an embodiment of the present invention.

FIG. 2 is a diagram illustrating variations of a multi-lever.

FIG. 3 is a circuit diagram of the minute-mass measuring system including a frequency sweeping circuit.

FIG. 4 is a diagram illustrating changes of vibration of the multi-lever.

FIG. 5 is a graph illustrating a control voltage generated by a sweep voltage generating device and oscillation amplitudes of signals detected from respective cantilevers.

FIG. 6 is a diagram illustrating correspondence relationship between measurement results and frequency changes.

FIG. 7 is a diagram explaining a detection method of the natural vibrational frequency (oscillatory frequency) of a cantilever.

FIG. 8 is a diagram explaining technique of removing errors.

FIG. 9 is a block diagram of a minute-mass measuring system of background art.

FIG. 10 is a diagram explaining an operation of the minute-mass measuring system of background art.

FIG. 11 is a diagram illustrating a procedure of measuring antigen-antibody reaction with the minute-mass measuring system of background art.

FIG. 12 is a diagram illustrating a result of measuring antigen-antibody reaction with the minute-measuring system of background art.

### BEST MODES FOR CARRYING OUT THE INVENTION

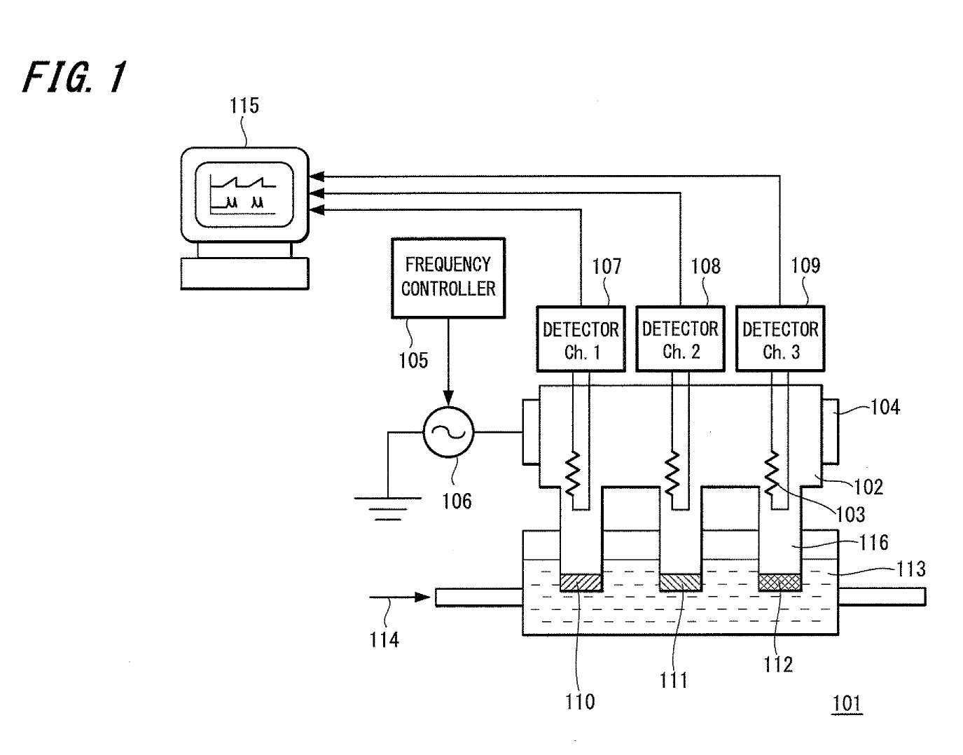

Below, an embodiment of the present invention is described referring to FIG. 1 through FIG. 8.

FIG. 1 is a block diagram of a minute-mass measuring system as an example of the present embodiment.

A multi-lever 102 is in a shape similar to the one in which a plurality of cantilevers is formed, which is disclosed in Non-patent Document 1. In respective cantilevers 116 constituting the multi-lever 102, piezoresistances 103 are buried.

In a root portion of the multi-lever 102, a vibration exciting piezoelectric element 104 is attached. The vibration exciting piezoelectric element 104 is configured to be driven by an oscillation source 106, which is controlled by a frequency controller 105.

The cantilevers 116 are connected with detectors 107, 108 and 109, respectively, and with these detectors 107, 108 and 109, the resistance values of the piezoresistances 103, which change based on the vibration generated by the vibration exciting piezoelectric element 104, are detected.

A PC system 115 A/D converts and records output signals of the detectors 107, 108 and 109, for a predetermined period of time. This PC system 115 constitutes a so-called data-logger. As the software for constituting the data-logger, for example, “LabVIEW” (registered trademark) of National Instrument Corporation, etc. are known.

On respective cantilevers 116, an antigen A 110, an antigen B 111, and an antigen C 112, which are different kinds of attracting objects, are coated. These are immersed in a liquid 113, such as water, etc., and if a measuring object 114, such as an antibody, a serum, etc., is put in, the quantities of the put-in measuring object 114 that are attracted differ from each other depending on the differences of the attracting objects. The differences appear as decreases in the self-excited frequency.

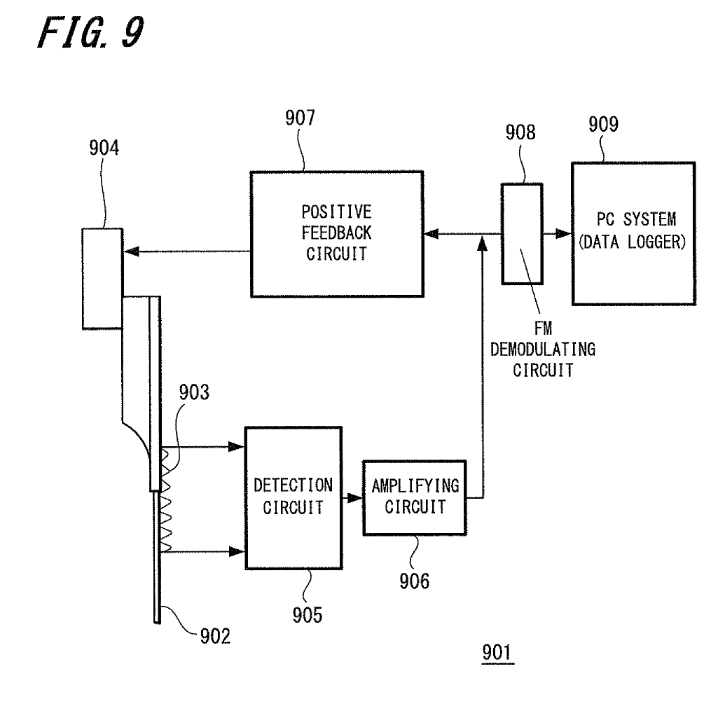

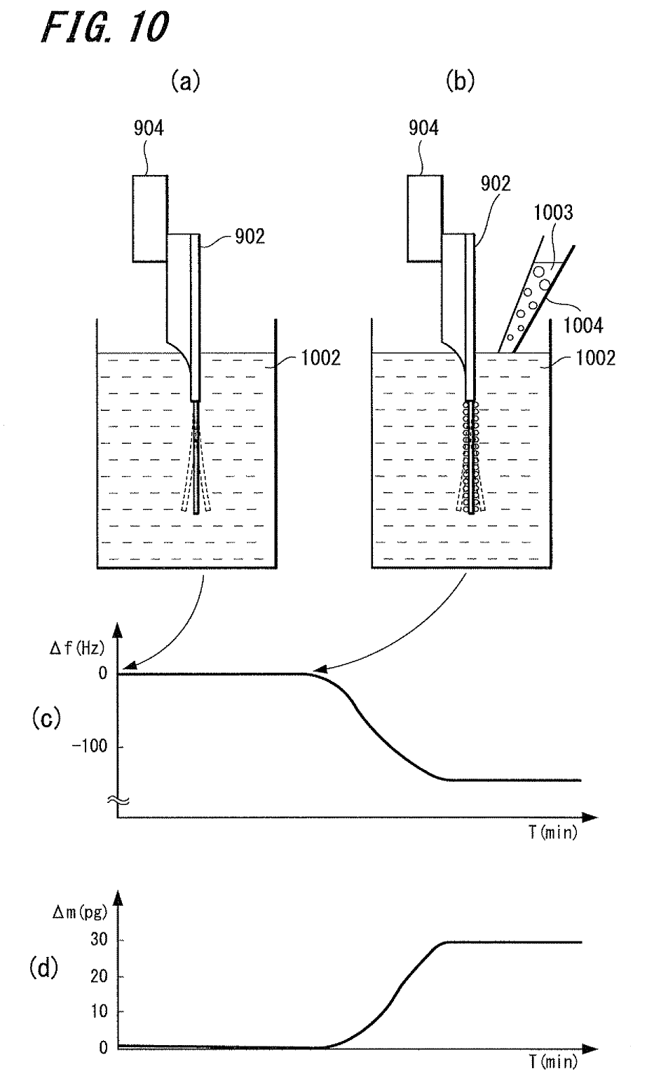

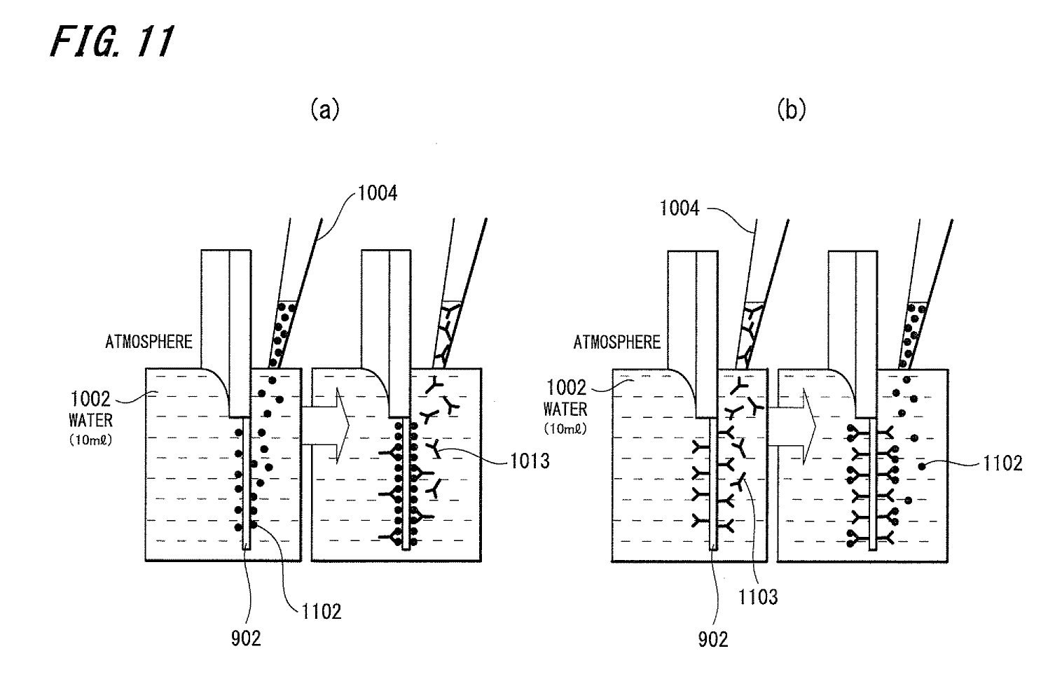

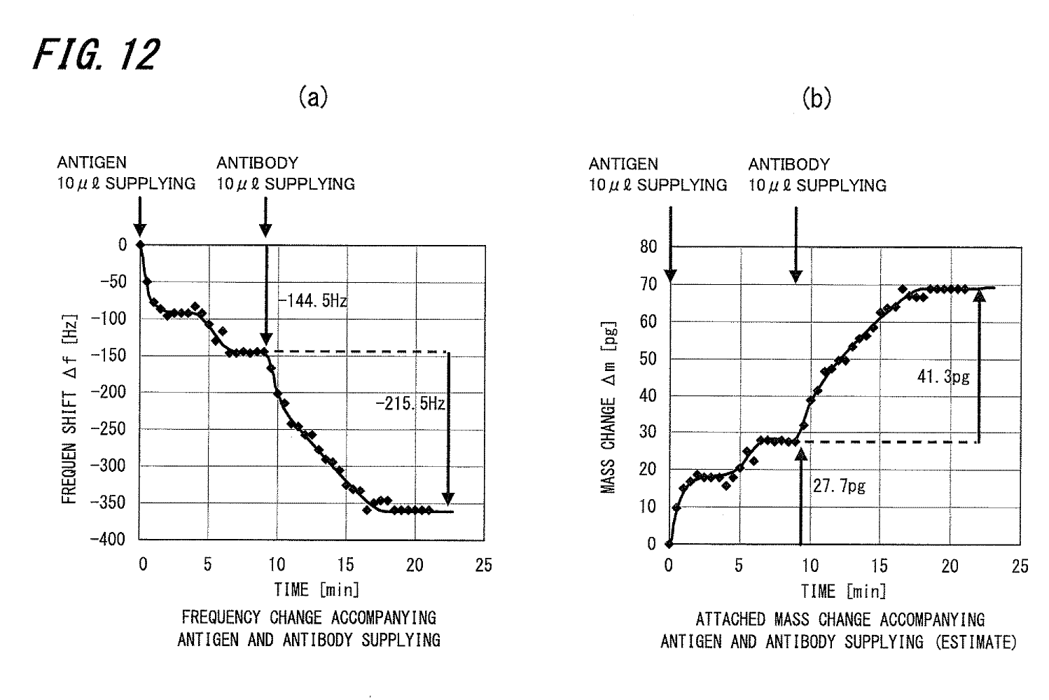

However, even if an oscillator is constituted using a cantilever of background art as illustrated in FIG. 9, it is impossible to measure the self-excited frequency thereof.

Accordingly, in the embodiment of the present invention, it is configured such that the frequency of vibration generated by the vibration exciting piezoelectric element 104 is swept with respect to a predetermined range by the frequency controller 105. Here, the predetermined range is a range covering the self-excited frequencies of the cantilevers 116.

In FIG. 1, as an illustration of the multi-lever 102, the cantilevers 116 having the same length are shown. However, the lengths of the cantilevers 116 need not be necessarily the same. Because, if the attracting objects that are coated are different, it is expected that the measurements are different, and even when the measurements are completely the same, the detectors 107, 108 and 109 are separate.

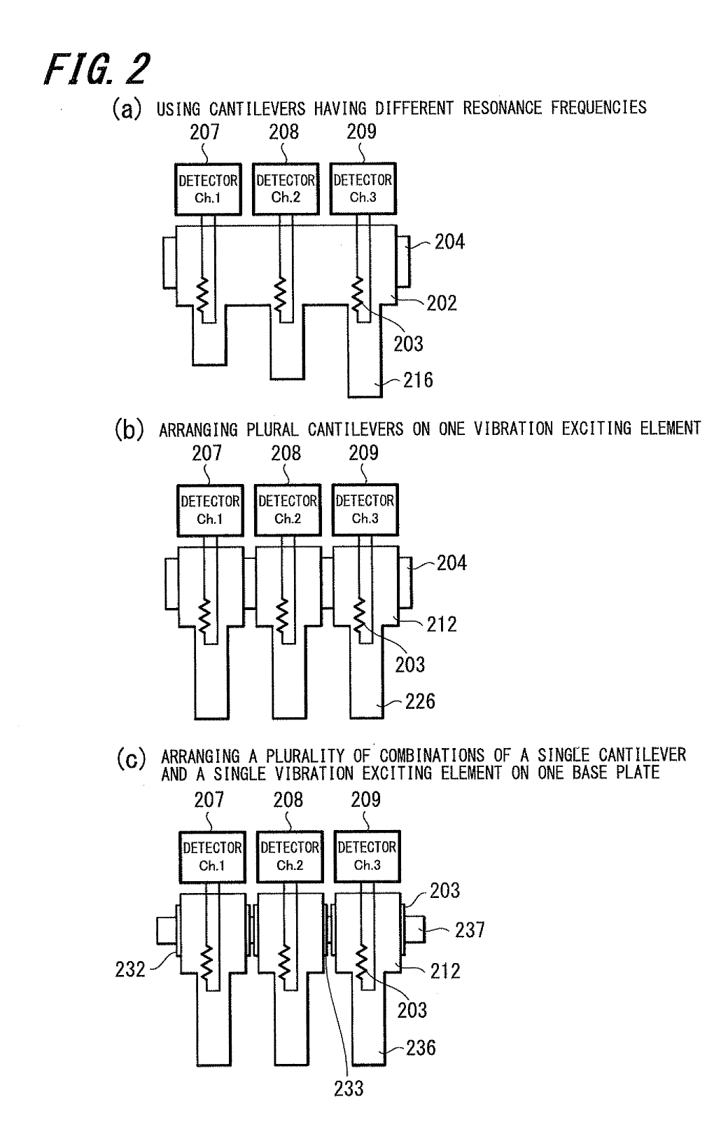

FIGS. 2(a) and 2(b) illustrate variations of the multi-lever.

As illustrated in FIG. 2(a), the lengths of cantilevers 216 may be made different from each other.

FIG. 2(b) illustrates that a plurality of single cantilevers 226 is arranged on the vibration exciting piezoelectric element 204. This is suitably applied to a case that the materials of the cantilevers 116 themselves need to be differentiated because of the characters of the measuring object.

That is, the lengths of cantilevers constituting a multi-lever need not be necessarily different from each other nor be completely the same. It is sufficient if the self-excited frequencies before the start and after the end of measurement can be measured.

Here, description is made with respect to the principle of detecting mass of a substance that is attached to the cantilever of the present embodiment.

If the cantilever is taken as a harmonic oscillator, the operation of the cantilever can be expressed by the equation for force shown as the following equation (1).

$$\begin{matrix}[ Equation 1 ] & \\ m \frac{{d}^{2} z}{d {t}^{2}} + a \frac{d z}{d t} + kz = {F}_{0} exp ( jω t ) & ( 1 )\end{matrix}$$

Note that;

“m” represents the effective mass of the cantilever,

“z” represents the distortion amount of the cantilever,

“k” represents the spring constant of the cantilever,

“a” represents the viscosity coefficient,

“F₀” represents the vibration exciting force of an actuator, and

“ω” represents the frequency of the actuator, i.e., the cantilever.

From the above-described equation (1), the resonance frequency “f” of the cantilever 10 can be expressed by the following equation (2) using the effective mass m, spring constant k, and viscosity coefficient a of the cantilever.

$$\begin{matrix}[ Equation 2 ] & \\ f = \frac{1}{2 π} \sqrt{\frac{k}{m} - \frac{{a}^{2}}{2 {m}^{2}}} & ( 2 )\end{matrix}$$

Note that when the viscosity resistance is small, the term −(a²/2 m²) of the equation (2) can be neglected. If the mass changes in the resonating state, the resonance frequency changes.

From the equation (2), the mass change can be obtained by the following equation (3).

$$\begin{matrix}[ Equation 3 ] & \\ Δ m = - 2 \cdot \frac{m}{f} \cdot Δ f & ( 3 )\end{matrix}$$

From the equation (3), it is understood that the mass change can be derived from the frequency change with an extremely simple equation.

By detecting the change of the frequency of the cantilever with the above-described equation (3), the change in the mass of the cantilever, that is, the mass of the substance attached to the cantilever, can be detected.

The measuring devices presently distributed in the market can measure the frequency change with accuracy of 1 Hz or below. From this, if the measuring system is assembled with high accuracy, using the above-described equation (3), the change in the mass of the cantilever can be measured in units of picogram or femtogram. For example, if the spring constant k is 1 N/m, the resonance frequency ω0 is 100 kHz, and the effective mass of the cantilever is 10 ng, it is possible to detect the mass of the substance attached to the cantilever with the sensitivity of about 200 fg/Hz.

Note that from the equation (3), by performing at least either of decreasing the mass of the cantilever and increasing the resonance frequency, the detection sensitivity can be further increased.

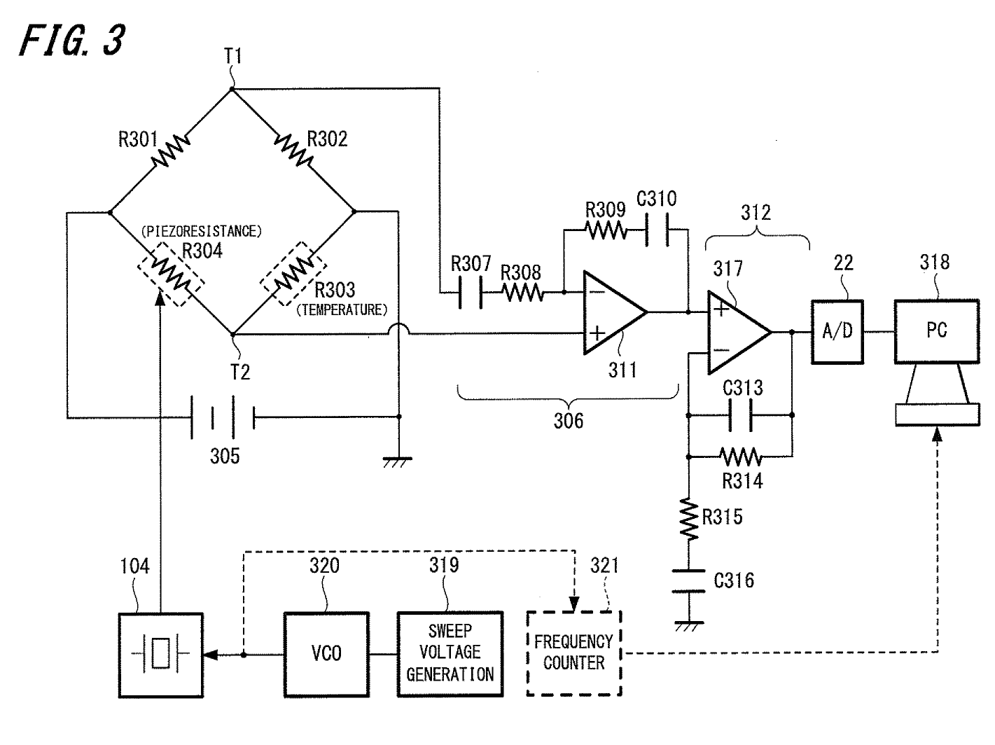

FIG. 3 is a circuit diagram of the minute-mass measuring system 101.

A resistance R304 is the piezoelectric resistance 103.

A resistance R303 is the piezoelectric resistance 103 for temperature compensation. A resistance R301 and a resistance R302 are resistances that constitute a Wheatstone bridge together with the resistance R303 and the resistance R304.

Condensers C307 and C310, resistances R308 and R309, and an operational amplifier 311 constitute an amplifier 306.

Condensers C313 and 0316, resistances R314 and R315, and an operational amplifier 317 constitute a bandpass filter (BPF) 312.

The voltage between a midpoint T1 of the resistance R301 and the resistance R302 and a midpoint T2 of the resistance R303 and the resistance R304 is subjected, after having been amplified at the subsequent amplifier 306, to noise removing at the BPF 312. Then, after having been subjected to A/D conversion at an A/D converter 322, data is recorded at a PC 318 in which data logger software operates.

A sweep voltage generator 319 serving as the frequency controller 105 generates voltage linearly changing in a predetermined voltage range. The voltage is gradually changed from the one corresponding to a low frequency to the one corresponding to a high frequency, and upon reaching the maximum frequency, the frequency change is stopped for a predetermined period of time. Then, the voltage is changed again from the low frequency to the high frequency. In response to the voltage of the sweep voltage generator 319, a VCO 320 serving as the oscillation source 106 oscillates. Obviously, the oscillatory frequency thereof changes depending on the voltage of the sweep voltage generator 319.

Then, the vibration exciting piezoelectric element 104 vibrates in response to the oscillation frequency of the VCO 320 to thereby vibrate the cantilever. The vibrational frequency of the vibration exciting piezoelectric element 104 is swept within a predetermined frequency range by the sweep voltage generator 319.

Further, at the PC 318 where the data logger software operates, the received data is analyzed. Here, AC waveforms are measured every predetermined period of time, and the number of waveforms is counted. That is, a frequency counter is constituted. Also, at the PC 318, integration of AC waveforms is performed every predetermined period of time, and peak values of the waveforms are obtained. That is, amplitude detection is carried out. Thus, in the example of the present embodiment, after taking in data, analysis thereof is carried out, so that analysis with high accuracy can be realized. Note that with respect to measurement of frequency, as illustrated by a dashed line in FIG. 3, a frequency counter 321 may be separately provided.

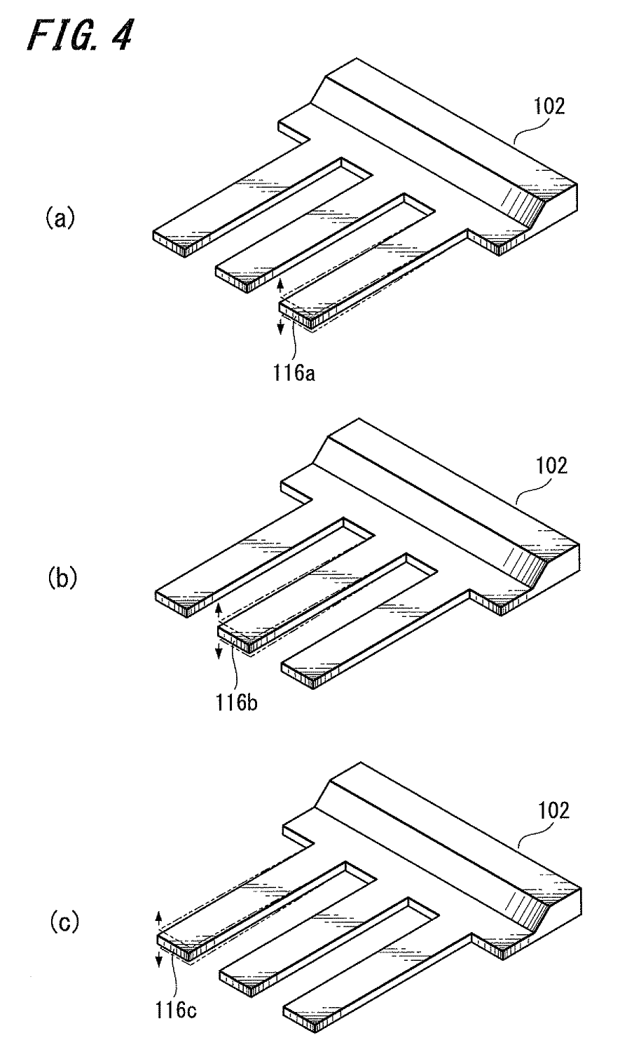

FIGS. 4(a), 4(b), and 4(c) illustrate changes of the vibration of the multi-lever 102.

In FIG. 4(a), if the vibration exciting piezoelectric element 104 starts to vibrate from a low frequency, after a short while, a cantilever 116a having the lowest natural vibrational frequency vibrates sympathetically.

In FIG. 4(b), if the vibrational frequency is further increased from the time point of FIG. 4(a), after a short while, a cantilever 116b having the next lowest natural vibrational frequency vibrates sympathetically. Also, in FIG. 4(c), when the vibrational frequency is further increased from the time point of FIG. 4(b), after a short while, finally, a cantilever 116c having the highest natural vibrational frequency vibrates sympathetically.

Note that in FIGS. 4(a), 4(b) and 4(c), the sympathetic vibration has occurred in order starting from the cantilever on the right to the cantilever on the left, however, this will change depending on the differences in length of the cantilevers 116 and the attaching degrees of the measuring object 114.

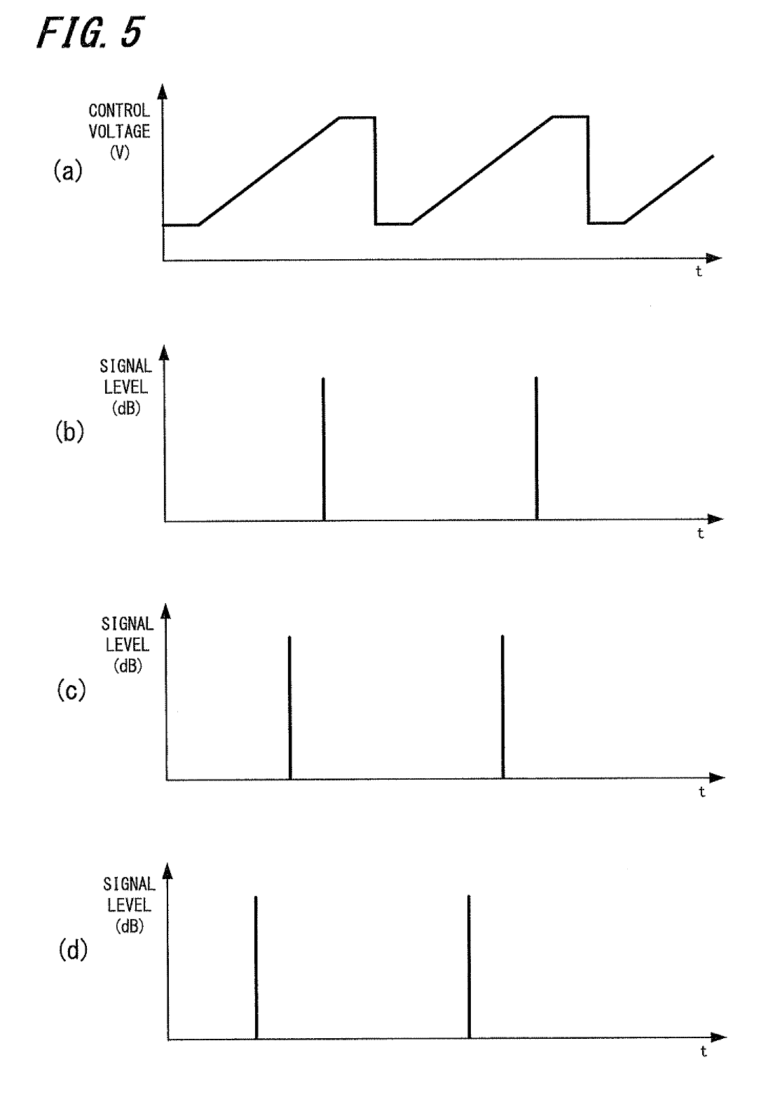

FIGS. 5(a), 5(b), 5(c), and 5(d) are graphs illustrating control voltages generated by the sweep voltage generator 319 and oscillation amplitudes of signals detected from respective cantilevers. The horizontal axis indicates time. It is understood that the signal amplitude increases only where sympathetic vibration is occurring.

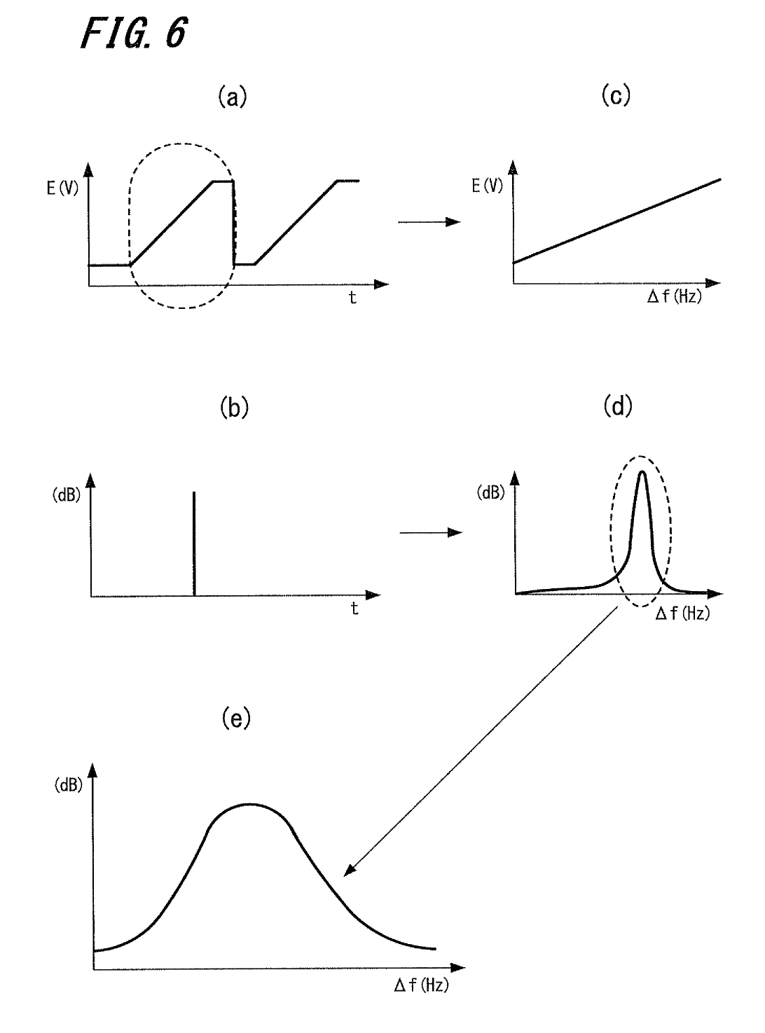

FIGS. 6(a), 6(b), 6(c), 6(d), and 6(e) are diagrams illustrating correspondence relationship between measurement results and frequency changes. Each diagram is in a form of a graph. FIGS. 6(a) and 6(b) are the same as FIGS. 5(a), 5(b), 5(c), and 5(d). That is, FIG. 6(a) illustrates, as in FIG. 5(a), changes of the control voltage of the sweep voltage generator 319 on the time axe, and FIG. 6(b) illustrates, as in FIGS. 5(b), 5(c), and 5(d), the signal amplitudes of the detectors 107, 108, and 109.

FIG. 6(c) is a graph illustrating a range encircled by a dotted line in FIG. 6(a) by converting the horizontal axis to the frequency. FIG. 6(d) is a graph illustrating, with respect to the range encircled by a dotted line in FIG. 6(a), the data of FIG. 6(b) by converting the horizontal axis to the frequency change. In actuality, with respect to the recorded data, frequency counting is carried out, for example, in units of 1/100 second, to detect the frequency, and the peak values of the waveforms are obtained as well in the same units of 1/100 second. That is, as discrete values, data of frequency-to-amplitude characteristic are obtained.

FIG. 6(e) is an enlarged graph of the range encircled by a dotted line in FIG. 6(d). The peak of this graph indicates the natural vibrational frequency of the concerned cantilever 116. Thus, based on the recorded data, the natural vibrational frequency of the concerned cantilever 116 is obtained.

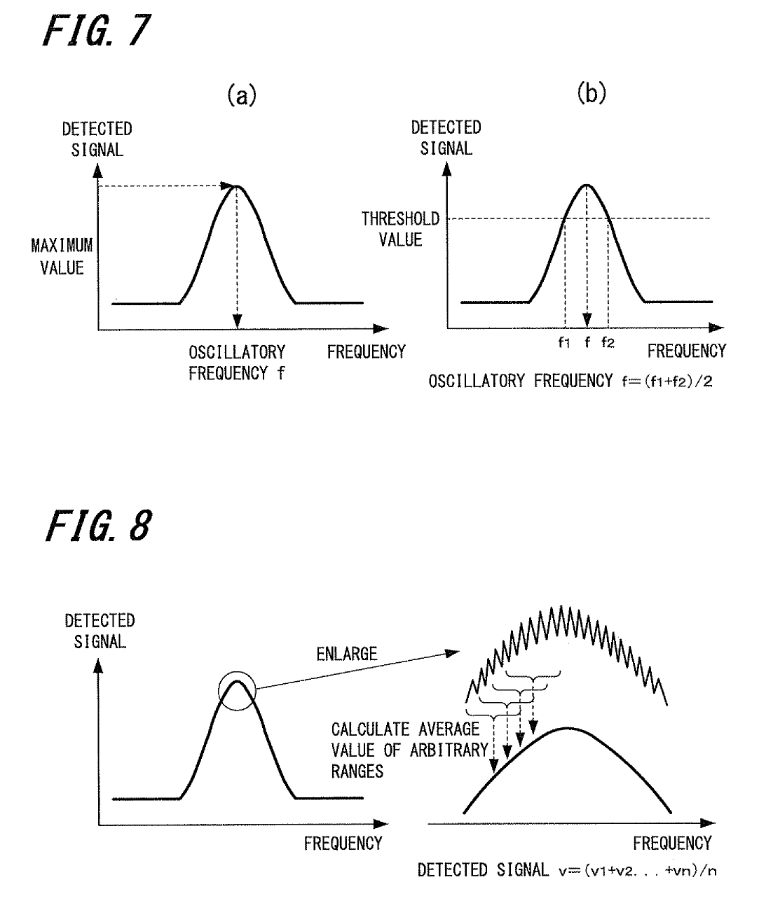

FIGS. 7(a) and 7(b) are diagrams explaining a detection method of the natural vibrational frequency (oscillatory frequency) of the cantilever 116. FIG. 7(a) illustrates, as in FIG. 6(e), a method of detecting the frequency corresponding to the peak value. FIG. 7(b) illustrates a method of slicing the graph with a threshold value and presuming the frequency at the middle point thereof to be the oscillatory frequency.

FIG. 8 is a diagram explaining technique of removing errors.

When actually measurement processing is carried out, even though the recorded data may macroscopically appear as in FIG. 8(a), microscopically there occurs a case that noise accompanies as in FIG. 8(b). In this case, the moving average is calculated with respect to arbitrary minute ranges, and the values are equalized. Thereafter, the oscillatory frequency is detected using the technique of FIG. 7(a) or FIG. 7(b).

The following applications are conceivable with respect to the present embodiment;

(1) As the detection element that is buried in the cantilever, instead of the piezoresistance element, a capacitance element, a piezoelectric element, and an electromagnetic induction element may be used. In this case, the generated voltage is amplified with an amplifier so as to be directly detected.

(2) As the vibration exciting element that vibrates the cantilever, instead of the piezoelectric element, an electrostatic type vibration exciting device and an electromagnetic type vibration exciting device may be used.

(3) There will be no problem even if the vibration exciting element is not a single unit. As in FIG. 2(c), by arranging pairs of a cantilever and a vibration exciting element on the common base table 237 and vibrating them by the common oscillator, the equivalent operational effects as in FIG. 1, FIG. 2(a), and FIG. 2(b) are obtained, as well.

(4) The cantilever may be a single unit. That is, it is possible to apply the circuit configuration of FIG. 3 to the cantilever 902 as a single unit shown in FIG. 9 and drive the vibration exciting actuator 904 with the frequency sweeping shown in FIGS. 6(a) and 6(c).

In the present embodiment, a minute-mass measuring system and a minute-mass sensor that is used in the system have been disclosed. With the present embodiment, a minute-mass measuring system can be realized, which is convenient and capable of detecting, based on mass changes, the attraction characteristics of an extremely minute substance due to the differences of the attraction substances.

It can be expected that the minute-mass measuring system of the present embodiment greatly contributes, particularly in the field of biotechnology, to the advancement of technology development, by shortening the time for measurement and reducing the labor.

So far, the description has been made with respect to the example of the embodiment of the present invention, however, the present invention is not limited to the above-described example of the embodiment, and it is needless to say that the invention includes other variations and applications insofar as they do not depart from the gist of the present invention described in Claims.

### Explanation of Reference Symbols;

101: minute-mass measuring system, 102: multi-lever, 103: piezoresistance, 104: vibration exciting element, 105: frequency controller, 106: oscillation source, 107, 108, 109: detectors, 110: antigen A, 111: antigen B, 112: antigen C, 113: liquid, 114: measuring object, 115: PC system, 116, 216, 226: cantilevers, 207, 208, 209: detectors, 204: vibration exciting piezoelectric element, 306: amplifier, 311, 317: operational amplifier, 312: bandpass filter, 318: PC, 319: sweep voltage generator, 320: VCO, 321: frequency counter, 322: A/D converter, R303: piezoresistance for temperature compensation, 8304: piezoresistance, R301, R302, R308, R309, R314, R315: resistances, C307, C310, C313, C316: condensers

1. A mass measuring apparatus comprising:
a first cantilever;
a first vibration detector attached to the first cantilever and configured to detect vibration of the first cantilever;
a second cantilever;
a second vibration detector attached to the second cantilever and configured to detect vibration of the second cantilever;
a single vibration exciting device to which the first cantilever and the second cantilever are attached and which applies vibration to the first cantilever and the second cantilever at the same time;
an oscillator configured to generate a signal that causes the vibration exciting device to vibrate at variable frequencies within a predetermined frequency range;
a recording device configured to record vibration detecting signals of the first vibration detector and the second vibration detector; and
a mass calculation unit configured to analyze data recorded in the recording device to measure natural vibrational frequencies of the first cantilever and the second cantilever, and calculate masses of measuring object substances attached to the first cantilever and the second cantilever based on the natural vibrational frequencies.

2. The mass measuring apparatus as described in claim 1, wherein measurement is carried out in a state that the first cantilever and the second cantilever are immersed in predetermined liquid after different measuring object substance attracting substances have been coated thereon.

3. The mass measuring apparatus described in claim 1, wherein the vibration detectors are piezoelectric resistance elements, capacitance elements, piezoelectric elements, or electromagnetic induction elements.

4. The mass measuring apparatus described in claim 1, wherein the vibration exciting device is a piezoelectric element, an electrostatic type vibration exciting device, or an electromagnetic induction type vibration exciting device.

5. A cantilever comprising:
a first cantilever;
a first vibration detector attached to the first cantilever and configured to detect vibration of the first cantilever;
a second cantilever;
a second vibration detector attached to the second cantilever and configured to detect vibration of the second cantilever; and
a single vibration exciting device to which the first cantilever and the second cantilever are attached and which applies vibration to the first cantilever and the second cantilever at the same time.

6. The cantilever described in claim 5, wherein the vibration exciting device is driven by a single oscillation source generating a signal that causes vibration at variable frequencies within a predetermined frequency range.

7. The cantilever described in claim 5, wherein measurement is carried out in a state that the first cantilever and the second cantilever are immersed in predetermined liquid after different measuring object substance attracting substances have been coated thereon.

8. The cantilever described in claim 5, wherein the vibration detectors are piezoelectric resistance elements, capacitance elements, piezoelectric elements, or electromagnetic induction elements.

9. The cantilever described in claim 5, wherein the vibration exciting device is a piezoelectric element, an electrostatic type vibration exciting device, or an electromagnetic induction type vibration exciting device.
